(19) United States
(12) Patent Application Publication
(10) Pub. No.: US 2010/0164239 A1
(43) Pub. Date: Jul. 1, 2010

(54) Lighted litter scoop

(76) Inventor: Sharon Grennan, Santa Cruz, CA (US)

Correspondence Address: Sharon Grennan, 154 Frnaklin St, Santa Cruz, CA, 95060, US

(21) Appl. No.: 12/317,762

(22) Filed: Dec. 30, 2008

(51) Int. Cl. A01K 29/00

(52) U.S. Cl. 294/1.3

(57) ABSTRACT

Lighted litter scoop with a hollow elongate handle, an elongate shaft member, a spoon shaped member, an LED lamp, a battery power source, a battery door and an on-off switch. The elongate shaft member is fixedly attached to the front end of the handle on one end and to the spoon shaped handle on the opposite end. The LED lamp is housed at the front end of the handle portion. The LED lamp is aimed at the the spoon shaped portion. The battery power source is enclosed within the hollow handle. The battery door is removable and replaceable and located on one surface of the hollow handle. The on-off switch is located on the top front surface of the handle allowing a user to hold the handle with one hand and press the on-off switch to activate the LED lamp.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pet care devices and more specifically to a lighted litter scoop.

With the advent of cat litter boxes, found in most homes of cat owners, it has become necessary to remove the cat poop from the litter box. It is a common practice to remove litter from a cat litter box by using a scooping tool that includes a handle, a shaft and a scoop member that includes a plurality of slits or holes to let the cat litter flow back into the litter box but to retain the cat poop for removal and disposal.

The litter removal tools are typically one piece plastic devices having a handle at one end and a scoop at the opposite end.

However, there is a deficiency in the prior technology in that it does not account for the condition of the darkened environment of a standard covered cat litter box thereby making it difficult to locate and remove all the cat litter that is residing in the cat litter box.

### BRIEF SUMMARY OF THE INVENTION

The primary object of the invention is to provide a litter scoop that includes an LED lamp that, when activated, helps a user to see and remove cat poop from the darkened environment of a cat litter box.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a lighted litter scoop comprising: a hollow elongate handle, an elongate shaft member, a spoon shaped member, an LED lamp, a battery power source, a battery door, an on-off switch, said elongate shaft member fixedly attached to the front end of said handle on one side and to said spoon shaped handle on the opposite side, said LED lamp housed at the front end of said handle portion, said LED lamp aimed at the said spoon shaped portion, said battery power source enclosed within said hollow handle, said battery door being removable and replaceable and located on one surface of said hollow handle, said on-off switch located on the top front surface of said handle, and allowing a user to hold said handle with one hand and press said on-off switch to activate said LED lamp.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention in use.

FIG. 3 is a side view of the invention.

FIG. 4 is a side section view of the invention.

FIG. 5 is a top plan view of the invention.

FIG. 6 is a rear view of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

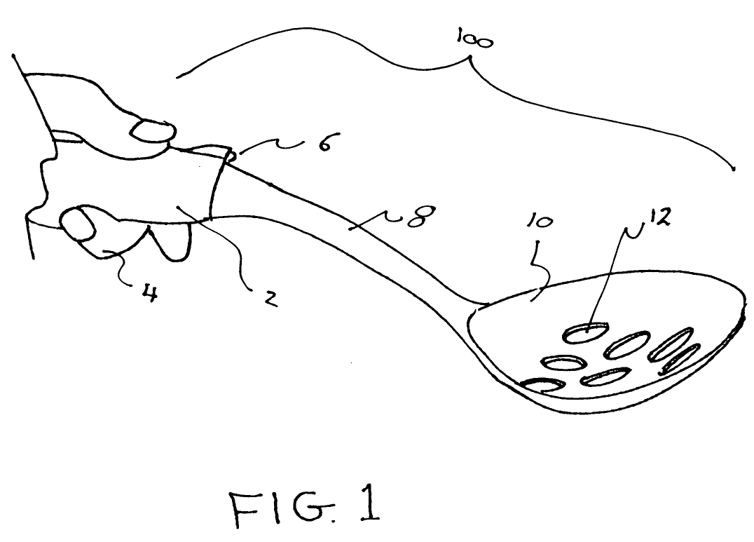

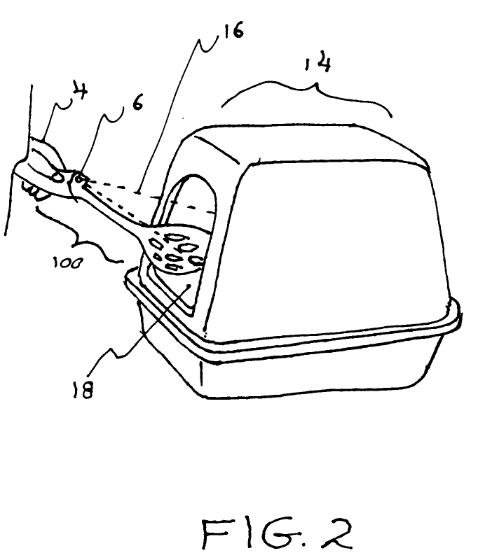

Referring now to FIG. 1 we see a perspective view of a person's hand 4 holding the handle 2 of the invention 100. The invention 100 is comprised of a handle portion 2, an elongate shaft portion 8 and a scoop portion 10. The scoop portion 10 is spoon shaped and has a plurality of apertures 12 in it that allow standard granulated cat litter to return to the standard cat litter box and to retain the larger cat poop within the spoon shape 10 for removal and disposal. An LED lamp 6 is positioned at the head of the handle portion 2 and, when activated, can illuminate the interior 18 of a standard cat litter box 14 as shown by dotted lines 16 in FIG. 2.

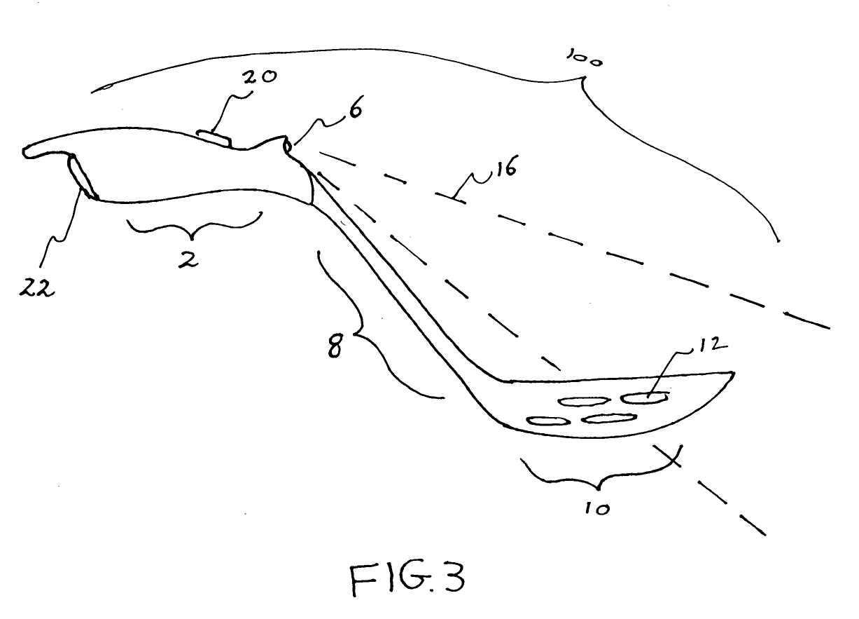

FIG. 3 shows a side view of the invention 100. The rear portion 22 of the handle 2 can be removed and replaced for removal and replacement of a battery stored within the hollow portion of handle 2. Push button 20 activates LED 6 when so desired. Light path 16 is clearly shown.

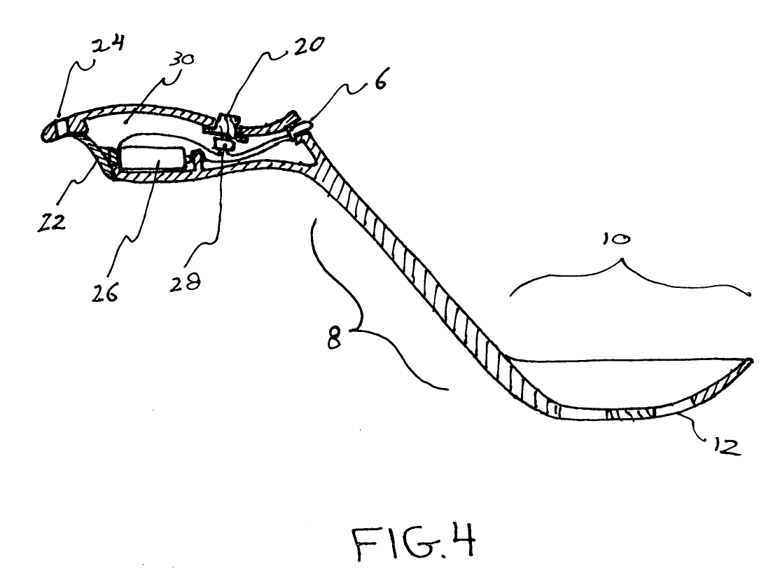

FIG. 4 shows a side section view of the invention. Battery power source 26 located within hollow portion 30 and is connected by electrical wires in a standard way to switch 28 and LED 6. Aperture 24 allows a person to hang the invention 100 on a hook when not in use. Battery door 22 can be clearly seen as a separate component that can be removed and replaced in a standard way. The entire assembly is constructed of injection molded rigid plastic such as ABS or polypropylene. Apertures 12 can be clearly seen in scoop portion 10.

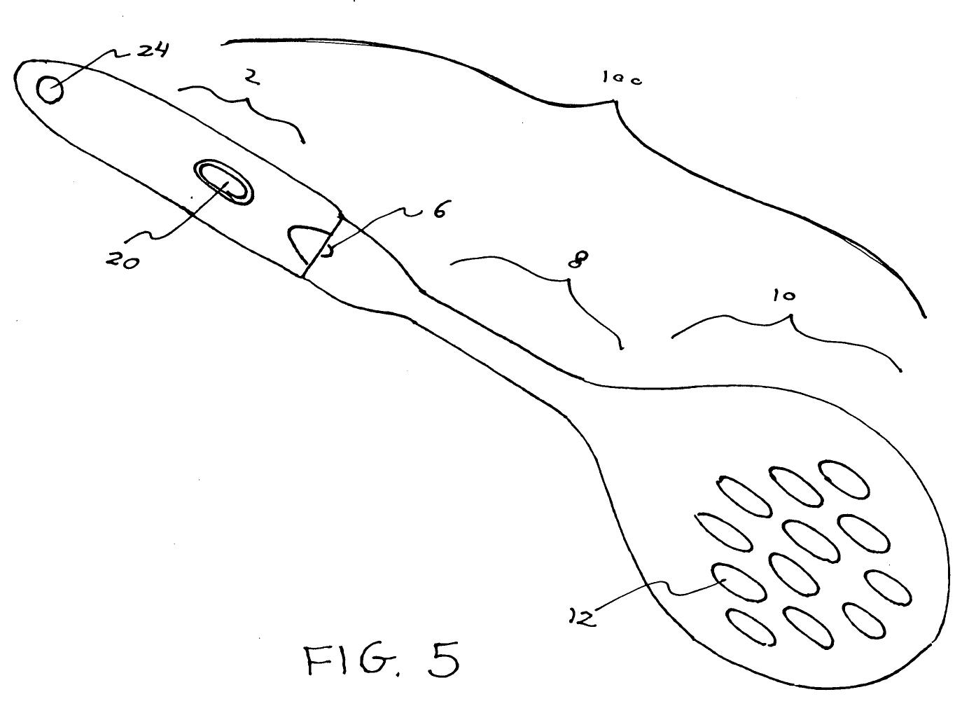

FIG. 5 is a plan view of the invention 100. Push button 20 can be clearly seen. Hanging aperture 24 can also be clearly seen. Scoop shape 10 is shown as a spoon shape, but can also be designed as a squared off shovel shape. Apertures 12 as shown as being elliptical, but can be other shapes such as round or elongated slits.

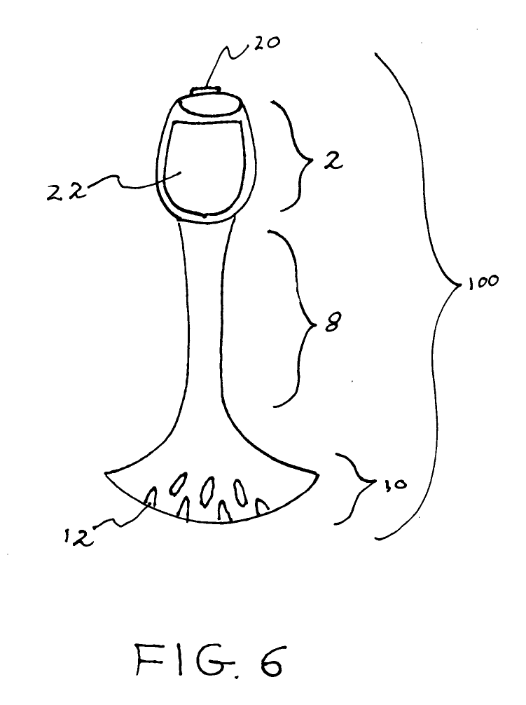

FIG. 6 shows a rear view of the invention 100. Removable battery door 22 can be clearly seen.

The above described and illustrated invention provides a novel means for a person to see more clearly into the darkened interior of a covered cat litter box when removing cat poop. The invention can also be used for other purposes such as cleaning out chicken coops or picking up dog poop outside at night.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Lighted litter scoop comprising:
a hollow elongate handle;
an elongate shaft member;
a spoon shaped member,
an LED lamp;
a battery power source;
a battery door;
an on-off switch;
said elongate shaft member fixedly attached to the front end of said handle on one end and to said spoon shaped handle on the opposite end;
said LED lamp housed at the front end of said handle portion;
said LED lamp aimed at the said spoon shaped portion;
said battery power source enclosed within said hollow handle;
said battery door being removable and replaceable and located on one surface of said hollow handle;
said on-off switch located on the top front surface of said handle; and
allowing a user to hold said handle with one hand and press said on-off switch to activate said LED lamp.
